(19) United States
(12) Patent Application Publication
(10) Pub. No.: US 2011/0133544 A1
(43) Pub. Date: Jun. 9, 2011

(54) Coupling Device for a Brake System of a Motor Vehicle with Handlebar Steering

(76) Inventor: Michael Ruopp, Berghulen (DE)

(21) Appl. No.: 13/012,970

(22) Filed: Jan. 25, 2011

Related U.S. Application Data
(63) Continuation of application No. PCT/EP2009/005428, filed on Jul. 27, 2009.

(30) Foreign Application Priority Data
Jul. 28, 2008 (DE) 102008035135.0

(51) Int. Cl. B60T 11/10; B62L 3/02; B62L 3/08; B62L 3/04; B60T 11/20

(52) U.S. Cl. 303/9.61; 303/9.62

(57) ABSTRACT

A coupling device (10) is used in a brake system of a motor vehicle with handlebar steering and having a hand-operated valve, a foot-operated valve, a front-wheel brake device and a rear-wheel brake device. The coupling device has a housing, a port (30) for the hand-operated valve, a brake cylinder section (15) for the front wheel brake, a brake piston (22) which is arranged in the brake cylinder section (15), and a port (20) for the front-wheel brake. The coupling device (10) has a port (40) for the foot-operated valve and a coupling piston (42) which is arranged between the brake cylinder section (15) and the port (40) for the foot-operated valve. The effective area, which acts for a hydraulic transmission of force, of the coupling piston (42) is smaller on the side facing toward the brake cylinder section (15) than on the side facing toward the port (40) for the foot-operated valve. The coupling piston (42) is arranged in a differential cylinder. The coupling device (10) has a stop, which is fixed to the housing, for the brake piston (22) for a movement in the direction of the port (30) for the hand-operated valve. The coupling device (10) has a valve device for closing off the hydraulic connection between the coupling piston (42) and the foot-operated valve.

The invention relates to a coupling device for a brake system of motor vehicles with handlebar steering, e.g. motorcycles, ATVs, quad bikes, etc. The invention also relates to an integral brake system on a motor vehicle with handlebar steering and having a coupling device of this kind.

It is the underlying object of the invention to specify a coupling device for a brake system of a motor vehicle with handlebar steering which, while being of simple construction, provides reliable operation and in which unwanted feedback of the actuation of the hand control to the foot control is preferably avoided.

A number of embodiments of the invention comprise a coupling device for a brake system of a motor vehicle with handlebar steering and having a hand control, a foot control, a front-wheel brake device and a rear-wheel brake device. The coupling device has a housing, a port for the hand control, a brake cylinder section for the front-wheel brake, a brake piston, which is arranged in the brake cylinder section, and a port for the front-wheel brake. The coupling device has a port for the foot control and a coupling piston, which is arranged between the brake cylinder section and the port for the foot control. The effective coupling-piston area, which is operative for hydraulic force transmission, is smaller on the side facing toward the brake cylinder section than on the side facing toward the port for the foot control, and/or the coupling piston is arranged in a differential cylinder.

These embodiments of the invention have the following advantage: the force exerted on the coupling piston by the foot control is generally (i.e. when the pressure exerted by the hand control corresponds approximately to the pressure exerted by the foot control) greater than the force exerted on the coupling piston by the hand control. The braking force exerted on the front-wheel brake when the hand control and the foot control are actuated simultaneously is therefore intensified by the coupling piston, while the braking force exerted on the rear-wheel brake remains substantially the same. Owing to the smaller effective area of the coupling piston on the side facing toward the brake piston, the force exerted by the hand control would have to be substantially greater than the force exerted by the foot control if it were the braking force for the rear-wheel brake which was to be intensified, rather than the braking force for the front-wheel brake. Such coupling is generally unwanted and should be avoided if possible. With an appropriate choice of effective-area ratio, this embodiment of the invention ensures that such unwanted coupling does not occur.

According to one embodiment of the invention, which is preferably designed as a development of the abovementioned embodiments of the invention, a coupling device is disclosed for a brake system of a motor vehicle with handlebar steering and having a hand control, a foot control, a front-wheel brake device and a rear-wheel brake device. The coupling device has a housing, a port for the hand control, a brake cylinder section for the front-wheel brake, a brake piston, which is arranged in the brake cylinder section, and a port for the front-wheel brake. The coupling device has a port for the foot control and a coupling piston, which is arranged between the brake cylinder section and the port for the foot control. The coupling device has a stop, which is fixed to the housing, for the brake piston for movement in the direction of the port for the hand control.

This embodiment of the invention has the following advantage: the stop has the effect that it is possible to define a brake piston end position which is defined with the tight tolerances of the stop. This has the advantage that losses through the compensating port are reduced in the case of the front-wheel brake system.

According to one embodiment of the invention, which is preferably designed as a development of the abovementioned embodiments of the invention, a coupling device is disclosed for a brake system of a motor vehicle with handlebar steering and having a hand control, a foot control, a front-wheel brake device and a rear-wheel brake device. The coupling device has a housing, a port for the hand control, a brake cylinder section for the front-wheel brake, a brake piston, which is arranged in the brake cylinder section, and a port for the front-wheel brake. The coupling device has a port for the foot control and a coupling piston, which is arranged between the brake cylinder section and the port for the foot control. The coupling device has a valve device for closing off the hydraulic connection between the coupling piston and the foot control.

This embodiment of the invention has the following advantage: by using the valve device, it is possible to deactivate integral operation, with this being preferred especially in off-road operations.

Providing a valve device between the coupling piston and the port for the foot control has the advantage that it is possible to achieve a braking effect with the rear-wheel brake even if the front-wheel brake fails. In this case, it must be possible to close off the valve device, even while the vehicle is in motion, if there is a pressure drop in the front-wheel brake. In addition to mechanical movement, electrical actuation of the valve device would also be conceivable. Another advantageous possibility would be automatic actuation of the valve device when a pressure drop in the front-wheel brake is detected by a pressure sensor, for example.

According to the invention, the ratio of the effective coupling-piston area which is operative for hydraulic force transmission on the side facing toward the brake cylinder section to the effective area which is operative for hydraulic force transmission on the side facing toward the port for the foot control can be 1:2 to 1:10, preferably 1:3 to 1:7 and, particularly preferably, approximately 1:4.

According to the invention, the diameter of the effective coupling-piston area which is operative for hydraulic force transmission on the side facing toward the brake cylinder section can be in a range of from 3 to 10 mm, preferably in a range of from approximately 4 to 8 mm, and preferably in a range of from 5 to 7 mm, and can preferably be approximately 6 mm.

According to the invention, the diameter of the effective coupling-piston area which is operative for hydraulic force transmission on the side facing toward the port for the foot control is in a range of from 10 to 20 mm, and preferably in a range of from approximately 11 to 15 mm, and is preferably approximately 13 mm.

According to the invention, the stop, which is fixed to the housing, for the brake piston can be formed by a disk preferably clamped against a flange provided in the housing of the coupling device.

According to the invention, the coupling piston can be provided at least in part in a cylinder section, which cylinder section is screwed into the housing of the coupling device and preferably clamps the disk against a flange provided in the housing of the coupling device.

According to the invention, the valve device can have a hollow screw arranged in the port for the foot control.

According to the invention, the valve device can have a mechanical valve device, which preferably comprises a spring-loaded Bowden control, a needle valve and/or a slide valve.

According to the invention, the valve device can have an electric valve device, which preferably comprises a solenoid valve.

According to the invention, a pressure sensor for measuring the pressure in the hand control and/or the pressure in the pressure space for the hand control and/or the pressure in the front-wheel brake system and/or the pressure in the foot control and/or the pressure in the pressure space for the foot control and/or the pressure in the rear-wheel brake system can be provided. For example, a pressure sensor can be provided in the hand control, in the coupling device and/or in the front-wheel brake system. Alternatively or additionally, it is also possible for a pressure sensor to be provided in the foot control and/or the rear-wheel brake system since, in the coupled condition, a fault in the front-wheel brake system also leads to a pressure drop in the rear-wheel brake system. Therefore, it is advantageous to deactivate the coupling by the valve device to ensure that a braking effect can be achieved. These embodiments of the invention have the advantage that automatic decoupling of integral operation is possible in the event of a front-wheel brake failure, when, for example, the absence of a pressure build-up when braking with the hand control and/or the foot control is detected.

According to the invention, the valve device can be arranged and designed in such a way that the valve device is open in the idle condition.

This embodiment of the invention has the advantage that the coupling device is switched automatically to integral operation when restarting, with this being obligatory for on-road operations.

According to the invention, the coupling piston can be a plunger piston. As an alternative, the coupling piston could also have a seal arranged in a groove.

According to the invention, the coupling device can comprise a tandem cylinder, with the brake piston preferably being arranged in a brake cylinder section and the coupling piston preferably being arranged in a differential cylinder section.

According to the invention, the coupling device can have a return spring which preloads the brake piston against a stop in the direction of the port for the hand control and/or preloads the coupling piston into its end position in the direction of the port for the foot control.

According to the invention, the coupling device can be designed as a tandem cylinder.

According to the invention, the coupling device and/or the valve device can be arranged and designed in such a way that the front-wheel brake device and the rear-wheel brake device are activated jointly when the valve device is in an open condition. Alternatively, a valve device is not present or is not provided.

According to the preferred embodiments of the invention, the coupling device and/or the valve device can be arranged and designed in such a way that joint activation of the brake devices takes place if at least the foot control is actuated when the valve device is in an open condition or no valve device is provided. In these embodiments of the invention, provision is preferably made for there to be no joint activation of the brake devices when the hand control is actuated. However, it is also conceivable according to the invention for joint activation to take place only or also when the hand control is actuated. Joint activation of the two brake devices is also referred to as integral operation.

According to the invention, an integral brake system for a vehicle with handlebar steering includes a tandem cylinder as a coupling device or includes a coupling device in accordance with one of the embodiments of the invention explained above.

According to one embodiment of the invention, a brake system for a motor vehicle with handlebar steering and having a hand control, a front-wheel brake device and a coupling device in accordance with one of the embodiments of the invention explained above is also disclosed, in which the compensating reservoir of the coupling device simultaneously functions as a compensating reservoir for the hand control. This has the advantage that the compensating reservoir of the hand control can be omitted. It is, of course, also possible for a hand control with a compensating reservoir to be used in accordance with the invention, when, for example, an already existing hand control is to be used with the hand control according to the invention.

The invention is described in greater detail below with reference to the illustrative embodiments shown in the figures:

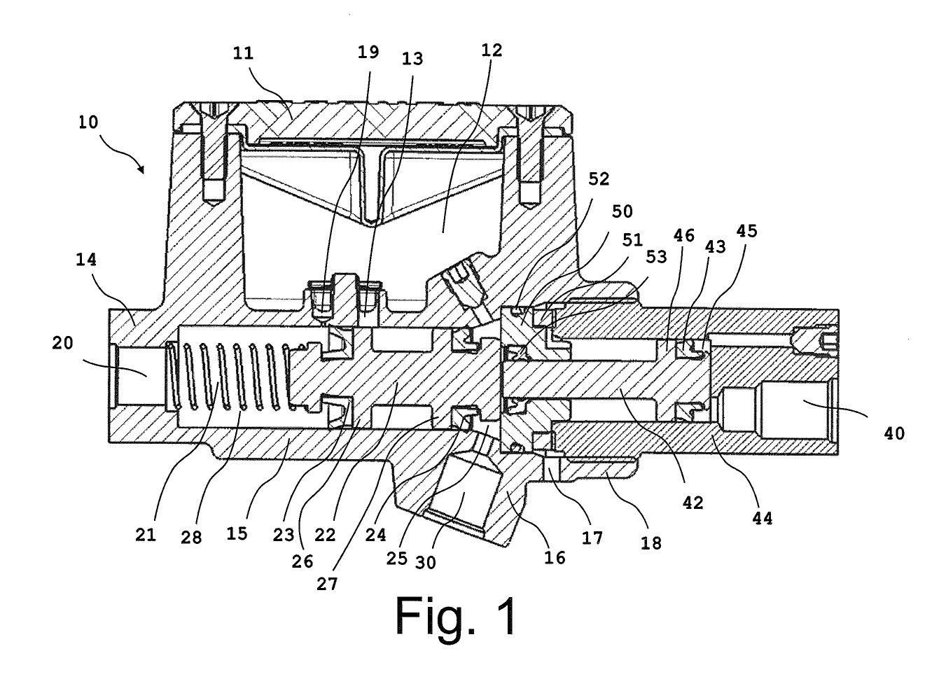

FIG. 1 shows a sectional view of a coupling device according to one embodiment of the invention.

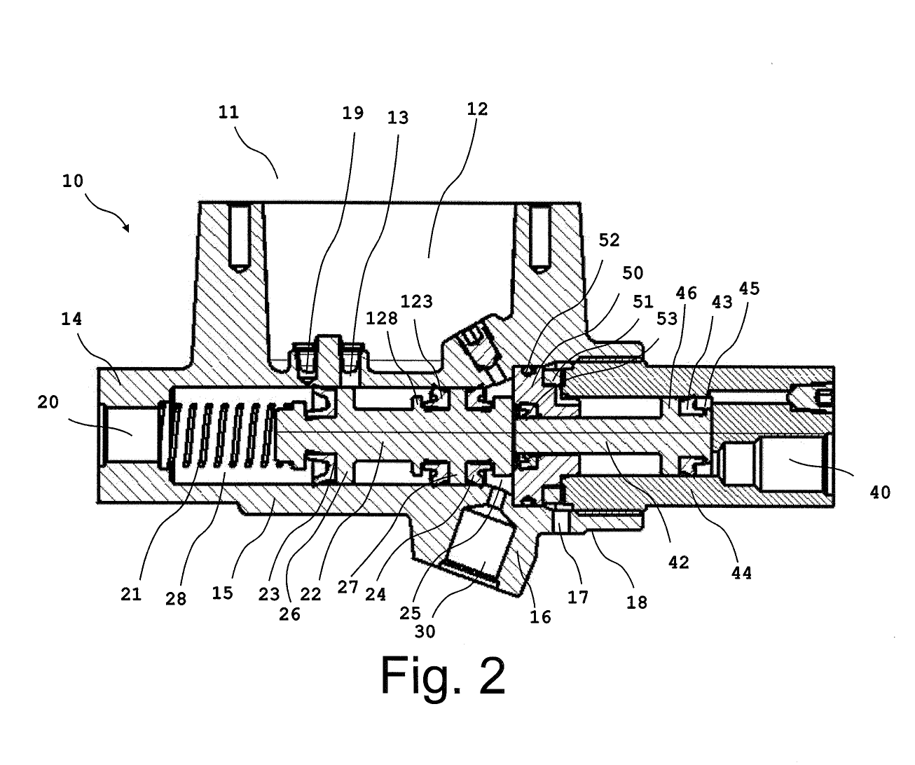

FIG. 2 shows a sectional view of a coupling device according to another embodiment of the invention.

The following reference signs are used in the description of the illustrative embodiments:
10 coupling device
11 cap
12 compensating reservoir
13 replenishing port
14 extension for port for front-wheel brake
15 brake cylinder section for front-wheel brake
16 extension for port for hand control
17 vent hole
18 extension for the connection of a cylinder section
19 compensating port
20 port for front-wheel brake
21 return spring
22 brake piston for front-wheel brake
23 seal or cup
24 seal
25 pressure space
26 flange
27 flange
28 pressure space
30 port for hand control
40 port for foot control and rear-wheel brake
42 coupling piston
43 seal
44 coupling piston cylinder section
45 pressure space
46 flange
50 disk
51 air filter
52 seal
53 seal (e.g. plunger seal or rod seal)
123 seal
128 flange

FIG. 1 shows a sectional view through a coupling device 10 according to a first embodiment of the invention. The coupling device 10 has a compensating reservoir 12 closed off by a cap 11. The compensating reservoir 12 is connected by a replenishing port 13 and a compensating port 19 to a brake cylinder section 15 for the front-wheel brake. Arranged in the brake cylinder section 15 for the front-wheel brake is a brake piston 22 for the front-wheel brake. The brake-piston 22 sealed off with respect to the cylinder in the brake cylinder section 15 by two seals 23, 24. The seal 23 is preferably designed as a cup. The brake piston 22 is preloaded by a return spring 21 counter to the direction of actuation. The coupling device 10 has an extension 14, in which a port 20 for a line leading to a front-wheel brake is provided. The return spring 21 thus pushes the brake piston 22 away from the port 20. Between the piston 22 and the port 20, there is a pressure space 28.

The coupling device 10 has an extension 16, in which a port 30 for a hand control for actuating the front-wheel brake is provided. In the depressurized condition, i.e. when the hand control is released, the return spring 21 preloads the brake piston 22 against a stop, which is fixed to the housing. In the illustrated embodiment of the invention, the fixed stop is formed by a disk 50 clamped against a projection or flange in the housing of the coupling device 10.

The coupling device 10 furthermore has a coupling piston 42 arranged in a coupling piston cylinder section 44 and coaxially with the brake piston 22. A port 40 for a line leading to a foot control and a rear-wheel brake is provided in the coupling device 10. The coupling piston 42 is sealed off by a seal 43 with respect to the cylinder arranged in the coupling piston cylinder section. With respect to the pressure space 25, the coupling piston 42 is sealed off by a seal 53, which seals off the coupling piston 42 with respect to the disk 50. The seal 53 is preferably designed as a plunger seal or rod seal. In the illustrative embodiment shown, the mounting groove for the seal 53 is provided in the cup. As an alternative, the mounting groove could also be provided in the coupling piston 42. In the illustrative embodiment shown, the seal 43 is provided on a flange 46 of the coupling piston 42. As an alternative, a seal could also be provided in a groove which is provided in the inner wall of the cylinder in the coupling piston cylinder section 44.

The seals 23 and 24 are secured on the brake piston 22 by flanges 26 and 27, respectively, formed on the brake piston 22. As an alternative, one or both seals could be provided in a groove formed in the cylinder of the brake cylinder section 14.

On its side facing toward pressure space 25, the coupling piston 42 has a smaller effective cross section than on the side facing toward the pressure space 45. The forces exerted on the coupling piston 42 by pressure spaces 25 and 45 are proportional to the pressures prevailing therein and to the respective effective areas. When the foot control and the hand control are actuated simultaneously, the coupling piston 42 is therefore pushed in the direction of the brake piston 22 until the ratio of the pressure in pressure space 25 to the pressure in pressure space 45 is no greater than the ratio of the effective area relative to pressure space 45 to the effective area relative to pressure space 25. Since the pressures in the two pressure spaces 25, 45 are generally equal in the case of simultaneous actuation of the brake, this ensures that there is no feedback from the hand control to the foot control but that part of the braking force is coupled from the foot control to the front-wheel brake when the hand control and the foot control are actuated, by virtue of the fact that the brake piston 22 is additionally subjected to pressure by the coupling piston 42.

To ensure that the effective area of the coupling piston 42 relative to pressure space 25 is smaller than the effective area of the coupling piston 42 relative to the pressure space 45, the cylinder formed in the coupling piston cylinder section 44 in the illustrated embodiment of the invention is designed as a differential cylinder. In other words, the inside diameter of the cylinder for the coupling piston 42 is smaller on its side facing toward the pressure space 25 than the inside diameter on the side facing toward the pressure space 45. In the embodiment illustrated, the reduction in the diameter of the cylinder is achieved by providing the disk 50, which is sealed off with respect to the pressure space 25 by a seal 52.

In the embodiment illustrated, the air-filled space between the flange 46 and the disk 50 is connected to ambient air via an air filter 51 and a vent hole 17. When the coupling piston 42 is extended in the direction of port 20, air escapes through the vent hole 17 and, when the coupling piston 42 is retracted, air is sucked back into the space between the flange 46 and the disk 50 through the vent hole 17 and the air filter 51. As an alternative, it would also be possible not to connect the air space between the flange 46 and the disk 50 to ambient air. In this case, the air in the space between the flange 46 and the disk 50 would be compressed during the extension of the coupling piston 42 in the direction of port 20, thus making it necessary to perform work against a pneumatic spring. This embodiment has the advantage that the maximum braking force coupled in by the foot control can be limited. In this embodiment, it would be advantageous to provide an additional seal, corresponding to seal 43 and acting in the other direction, on the flange 46.

FIG. 2 shows an alternative embodiment of the invention, which corresponds substantially to the embodiment in FIG. 1. Components that are the same have been denoted by the same reference signs. In this respect, reference is made to the description of the illustrative embodiment in FIG. 1. Only the differences with respect to the illustrative embodiment in FIG. 1 are described below.

In the illustrative embodiment in FIG. 2, a seal 123, which is provided between the flange 27 and a further flange 128, is also provided on the brake piston 22. This embodiment has the advantage that the system can be charged with excess pressure, thereby making it feasible to achieve a possible interaction between the hydraulic systems of the front-wheel brake system and the rear-wheel brake system.

In the embodiments illustrated, the coupling device 10 has an extension 18, in which an internal thread is provided. A cylinder section provided with a corresponding external thread forms a section of the coupling piston cylinder section 44 with a larger inside diameter and is screwed into the thread in the extension 18. During this process, the disk 50 is clamped against a stop in the housing, thus providing a defined end position for the brake piston 22. The defined end position of the brake piston 22 is determined solely by the manufacturing tolerances of the stop for the disk 50. This has the advantage that the brake piston 22 can be provided with tighter tolerances, thus allowing maximum speed of movement over the compensating port 19 so as to avoid losses during braking and delays in the response of the brake. When the brake piston 22 is supported on the coupling piston 42 and not against the stop fixed to the housing, the manufacturing tolerances of the coupling piston 42 must be taken into account in the design of the brake piston 22, and the manufacturing tolerances of the stop on the housing must be taken into account in the design and dimensioning of the brake piston 22. Rather than having two sets of manufacturing tolerances to take into account, the compensating port 19 is generally traversed later, resulting in a delayed brake response.

The operation of the coupling device 10 in the illustrative embodiments in FIGS. 1 and 2 will be described below.

When the hand control is actuated, pressure is built up in pressure space 25, and the brake piston 22 moves counter to the force of the return spring 21 in the direction of port 20. Once the compensating port 19 has been traversed, pressure builds up in pressure space 25, pressure space 28 and the front-wheel brake system. Since the foot control is not actuated, no pressure builds up in pressure space 45, and the coupling piston 42 is pushed into the coupling piston cylinder section, against its stop. The vehicle is braked by way of the front-wheel brake alone.

When the foot control is actuated, pressure builds up in the rear-wheel brake system and pressure space 45. As a result, the coupling piston 42 moves in the direction of the brake piston 22 and moves the latter in the direction of port 20 counter to the force of the return spring 21. As soon as the compensating port 19 has been traversed, a pressure which exceeds the force of the return spring 21 builds up in pressure space 45, bringing about braking of the motor vehicle with the rear-wheel brake system and the front-wheel brake system. When the foot control is actuated, the front-wheel brake and the rear-wheel brake are thus acted upon with a specific ratio of forces, i.e. in a specific ratio which is determined by the arrangement and dimensioning of the components.

If the hand control and the foot control are actuated simultaneously, pressure builds up in pressure space 25 and in pressure space 45 as soon as the compensating port 19 has been traversed by the brake piston 22. Due to the pressure in pressure space 25, the brake piston 22 is pushed in the direction of port 20, counter to the force of the return spring 21. The coupling piston 42 is pushed in the direction of the brake piston 22 by the pressure in pressure space 45, counter to the pressure in pressure space 25, and imposes upon it an additional force, provided that the pressure ratio of pressure space 45 to pressure space 25 is no less than the ratio of the effective area for pressure space 45 to that of the effective area for the pressure space 25 for the coupling piston 42. As a result, the rear-wheel brake system is subjected to pressure exclusively by the foot control, and the front-wheel brake system is subjected to pressure by the hand control and, in part, by the foot control. The hydraulic pressure is coupled from the foot control to the brake piston 22 mechanically by the coupling piston 42.

The embodiment according to the invention could also be referred to as a coupling device 10 with a tandem cylinder which has a brake cylinder and a differential cylinder. In other words, the brake piston 22 is arranged in a brake cylinder, and the coupling piston 42 is arranged in a differential cylinder.

In order to achieve braking with the rear-wheel brake system alone, it is necessary to deactivate integral operation, with this being advantageous for off-road use, for example. For this purpose, a valve device can be provided in port 40, for example, with this being in accordance with an illustrative embodiment which is not shown.

The valve device can comprise a valve, preferably a solenoid valve, which is preferably arranged in the port 40 (see FIGS. 1 and 2) for the foot control or rear-wheel brake (not shown). According to a preferred embodiment of the invention, which is not shown in the figures, the valve shuts when energized, in particular when pressure builds up via the hand control. For this purpose, the valve is preferably closed by an electromagnet. As soon as the ignition is switched off, the valve is preferably deenergized by a relay. The valve is preferably preloaded by a return spring, which is preferably arranged in or at the magnet that, when deenergized, the valve returns automatically to its open starting position. This has the advantage that integral operation is always set when the vehicle is started, in line with the requirement of legislators. In accordance with the embodiments of the invention which make provision for this, it can subsequently be deactivated deliberately by the driver, if appropriate.

According to a preferred embodiment of the invention, a button or switch can be provided on the handlebar, by which an electromagnet for actuating the solenoid valve can be energized. In integrated systems, the electromagnet can execute a stroke of 0.5 mm, for example, to close the valve in order to press into a valve seat a piston which is, for example, integrated into the magnet or separate. As soon as the ignition circuit is interrupted, a return spring, for example, can return the magnet to its starting position.

Such solenoid valves are known to a person skilled in the art. The RP16X9 push-type solenoid valve supplied by Magnet-Schultz of America, Westmont, Ill., USA can be used, for example. It is advantageous if the piston is designed and arranged in such a way that, when the valve is closed, it is pushed further into the valve seat by the actuation of the hand control in order to reliably avoid unwanted opening of the valve. The surface ratios on the piston should preferably be chosen in such a way that only slight forces are required to actuate the valve. For example, an actuating force of 5 N could be sufficient in the case of a piston stroke of 0.5 mm, in which case it would be possible to provide a return spring with a spring force of 2 N, for example.

According to one embodiment of the invention, the deactivation of integral operation could be coupled with a navigation device (GPS, etc.) in such a way that deactivation of integral operation on the road is actively prevented or that integral operation is automatically reactivated as soon as the navigation system detects that the vehicle is on a road. If appropriate, a warning device can be provided in order to inform the driver on the activation of integral operation. Alternatively or in addition, confirmation from the driver that integral operation should be reactivated can be demanded. This safety function can preferably be activatable and deactivatable in a manner corresponding to a passenger airbag.

It is clear that alternatives and equivalent solutions which are obvious to a person skilled in the art examining the documents are also intended to fall within the scope of protection of the claims. For example, a flange which is integral with the housing can be provided instead of a cup as a brake piston stop fixed to the housing of the coupling device.

1. A coupling device for a brake system of a motor vehicle with handlebar steering, with the motor vehicle having a hand control, a foot control, a front-wheel brake device and a rear-wheel brake device, the coupling device comprising:
a housing, a port for the hand control, a brake cylinder section for the front-wheel brake, a brake piston arranged in the brake cylinder section, a port for the front-wheel brake device, a port for the foot control, and a coupling piston arranged between the brake cylinder section and the port for the foot control, wherein:
an effective coupling-piston area of the coupling piston operative for hydraulic force transmission is smaller on a first side facing toward the brake cylinder section than on a second side facing toward the port for the foot control, and/or
the coupling piston is arranged in a differential cylinder, and/or
the coupling device further comprises a stop fixed to a housing for the brake piston for a movement in a direction of the port for the hand control, and/or
the coupling device further comprises a valve device closing off hydraulic connection between the coupling piston and the foot control.

2. The coupling device as claimed in claim 1, wherein a ratio of the effective coupling-piston area operative for hydraulic force transmission on the first side facing toward the brake cylinder section to the effective coupling piston area operative for hydraulic force transmission on the second side facing toward the port for the foot control is 1:2 to 1:10.

3. The coupling device as claimed in claim 1, wherein a diameter of the effective coupling-piston area operative for hydraulic force transmission on the first side facing toward the brake cylinder section is in a range of from 3 to 10 mm.

4. The coupling device as claimed in claim 1, wherein a diameter of the effective coupling-piston area operative for hydraulic force transmission on the second side facing toward the port for the foot control is in a range of from 10 to 20 mm.

5. The coupling device as claimed in claim 1, wherein the stop fixed to the housing for the brake piston is formed by a disk clamped against a flange provided in the housing.

6. The coupling device as claimed in claim 5, wherein the coupling piston is provided at least in part in the brake cylinder section screwed into the housing and clamps the disk against the flange provided in the housing.

7. The coupling device as claimed in claim 1, wherein the valve device has a hollow screw arranged in the port for the foot control.

8. The coupling device as claimed in claim 1, wherein the valve device has a mechanical valve device comprising a spring-loaded Bowden control, a needle valve and a slide valve.

9. The coupling device as claimed in claim 1, wherein the valve device has an electric valve device.

10. The coupling device as claimed in claim 1, further comprising a pressure sensor measuring pressure in at least one of the hand control, a pressure space for the hand control, the front-wheel brake device, the foot control, a pressure space for the foot control and the rear-wheel brake device.

11. The coupling device as claimed in claim 1, wherein the valve device is open in an idle condition.

12. The coupling device as claimed in claim 1, wherein the coupling piston is a plunger piston.

13. The coupling device as claimed in claim 1, further comprising a tandem cylinder, with the brake piston being arranged in the brake cylinder section of the tandem cylinder and the coupling piston being arranged in a differential cylinder section of the tandem cylinder.

14. The coupling device as claimed in claim 1, further comprising a return spring which preloads the brake piston against the stop in a direction of the port for the hand control and preloads the coupling piston into an end position in a direction of the port for the foot control.

15. The coupling device as claimed in claim 1, further comprising a tandem cylinder.

16. The coupling device as claimed in claim 1, wherein the front-wheel brake device and the rear-wheel brake device are activated jointly when the valve device is in an open condition.

17. An integral brake system for a vehicle with handlebar steering, having a coupling device as claimed in claim 1.
